(19) United States
(12) Patent Application Publication
(10) Pub. No.: US 2015/0128814 A1
(43) Pub. Date: May 14, 2015

(54) Apparatus and Method for Making Tea Latte

(71) Applicant: CAMELLIA LABS INC., San Mateo, CA (US)

(72) Inventor: Gaurav Chawla, Foster City, CA (US)

(73) Assignee: CAMELLIA LABS INC., San Mateo, CA (US)

(21) Appl. No.: 14/541,000

(22) Filed: Nov. 13, 2014

Related U.S. Application Data
(60) Provisional application No. 61/904,281, filed on Nov. 14, 2013.

(51) Int. Cl. A47J 31/46; A47J 31/54

(52) U.S. Cl. CPC A47J 31/462; A47J 31/54
USPC 99/300

(57) ABSTRACT

An apparatus includes a body, a first container for positioning on the body and a second container for positioning on the body. An interface is positioned on the body to accept preparation parameters for tea latte. A boiler within the body receives water from the first container and milk from the second container. A heater adjacent to the boiler heats the water and the milk in accordance with at least one preparation parameter. A filter and a dispensing valve are controlled electronically.

### CROSS-REFERENCE TO RELATED APPLICATION

This application claims priority to U.S. Provisional Patent Application Ser. No. 61/904,281, filed Nov. 14, 2013, the contents of which are incorporated herein by reference.

### FIELD OF THE INVENTION

This invention relates generally to beverage preparation. More particularly, this invention relates to techniques for making tea latte.

### BACKGROUND OF THE INVENTION

Tea latte is a combination of tea and milk. Masala chai (Indian spiced chai-tea latte) comprises water, milk, loose tea, various spices and sweetener. Spices used to make chai tea may include ginger, cardamom, pepper, cinnamon, mint, lemon grass, cloves, star anise, fennel seeds, saffron, nutmeg, coriander, basil, licorice, rose, etc.

Tea latte is typically prepared through a manual process. It would be desirable to at least partially automate the process of preparing tea latte.

### SUMMARY OF THE INVENTION

An apparatus includes a body, a first container for positioning on the body and a second container for positioning on the body. An interface is positioned on the body to accept preparation parameters for tea latte. A boiler within the body receives water from the first container and milk from the second container. A heater adjacent to the boiler heats the water and the milk in accordance with at least one preparation parameter. A temperature sensor measures the temperature of the liquid inside the boiler. An electronically controlled valve controls the flow of the liquid from the boiler.

### BRIEF DESCRIPTION OF THE FIGURES

The invention is more fully appreciated in connection with the following detailed description taken in conjunction with the accompanying drawings, in which:

FIG. 1 is a side view of an apparatus configured in accordance with an embodiment of the invention.

FIG. 2 is an interior view of an apparatus configured in accordance with an embodiment of the invention.

Like reference numerals refer to corresponding parts throughout the several views of the drawings.

### DETAILED DESCRIPTION OF THE INVENTION

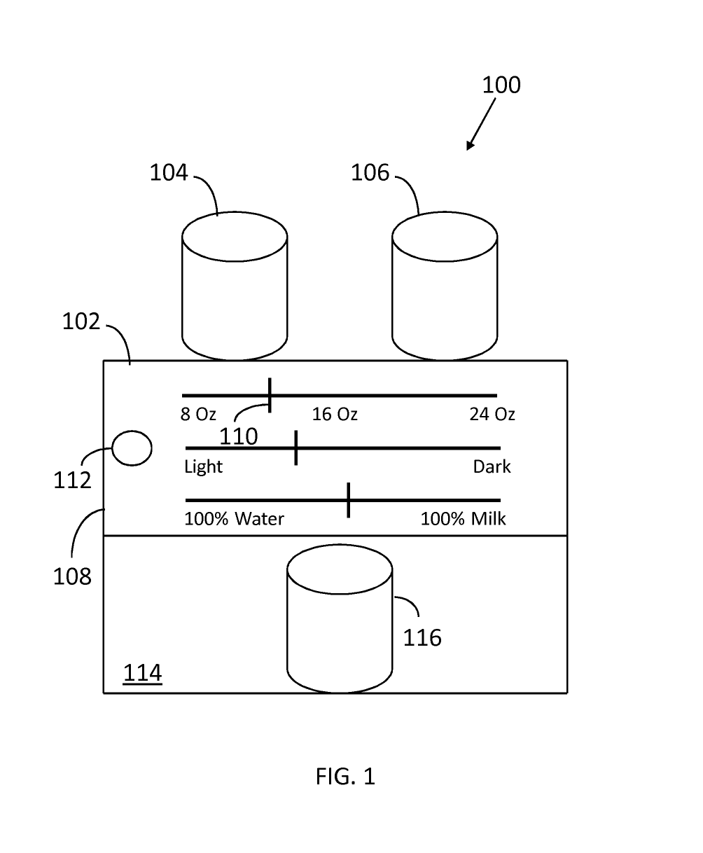

FIG. 1 is a side view of an apparatus 100 for preparing tea latte. The apparatus 100 includes a body 102 that supports a first container 104 holding water and a second container 106 holding milk. Either container may be removable. In the case of the container holding milk, it is desirable to have a removable configuration so that unused milk can be placed in a refrigerator. The base of each container has a movable disc (e.g., spring loaded) for engagement with a valve, as discussed below.

The body 102 supports a display 108. The display 108 accepts preparation parameters for tea latte. For example a slider 110 may be used to specify a tea latte serving size. Other sliders may be used to specify the strength of the tea latte (ranging from a light to dark scale). Another slider may be used to specify fluid mixture percentage (ranging from 100% water to 100% milk). The sliders may be mechanical devices. Alternately, display 108 may be a touch display responsive to physical gestures. The display also includes a start button 112. The start button 112 may present process information, such as heating, brewing, ready and the like.

The body 102 defines an aperture 114. A cup 116 may be placed in the aperture to receive brewed tea latte.

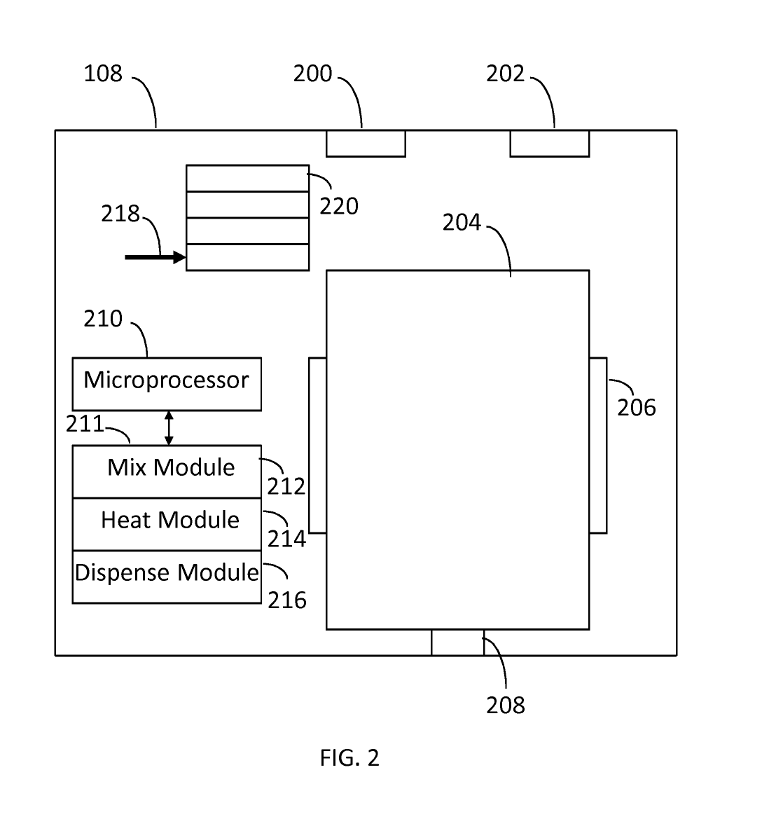

FIG. 2 is an interior view of the apparatus of FIG. 1. The interior view is not to scale. The body includes a first valve 200 to interface with the first container and a second valve 202 to interface with the second container. Fluid from each valve drips into boiler 204. Alternatively, pumps may be used to transport the fluids. Boiler 204 has an associated heater 206. The boiler has a third valve 208 to dispense brewed tea latte. A filter may be positioned between the boiler 204 and valve 208 to trap residue. In one embodiment, the filter is removable.

A microprocessor 210 is connected to a memory 211. The memory 211 stores instructions to control the brewing process. A mix module 212 includes instructions executed by the microprocessor 210 to process a preparation parameter related to percentage of water and milk. The mix module 212 may also include instructions to process a preparation parameter related to serving size.

A heat module 214 includes instructions executed by the microprocessor 210 to control the heater 206 and therefore the brewing process. A dispense module 216 includes instructions executed by the microprocessor 210 to control valves 200, 202 and 208. Thus, the dispense module 216 controls fluid intake to the boiler 204 and the dispensation of tea latte to a cup. An actuator 218 may be controlled by the microprocessor 210 to move a tea cartridge 220 into the boiler 204.

Preferably, the apparatus is configured for some manual operations. For example, the first container and the second container need not be used. Rather, the boiler 204 may be removed from the body 108. A milk, water and tea combination may be prepared in the boiler 204 while outside the body 108. The boiler may then be placed within the body 108. A user may then specify tea latte strength on the interface 108 and push the start button 112.

An embodiment of the present invention relates to a computer storage product with a non-transitory computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media, optical media, magneto-optical media and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. An apparatus, comprising:
a body;
a first container for positioning on the body;
a second container for positioning on the body;
an interface positioned on the body to accept preparation parameters for tea latte;
a boiler within the body to receive water from the first container and milk from the second container; and
a heater adjacent to the boiler to heat the water and the milk in accordance with at least one preparation parameter.

2. The apparatus of claim 1 wherein the interface is configured to accept a tea latte size preparation parameter.

3. The apparatus of claim 1 wherein the interface is configured to accept a tea latte strength preparation parameter.

4. The apparatus of claim 1 wherein the interface is configured to accept a water and milk percentage preparation parameter.

5. The apparatus of claim 1 further comprising a first valve for releasing water from the first container into the boiler.

6. The apparatus of claim 1 further comprising a second valve for releasing milk from the second container into the boiler.

7. The apparatus of claim 1 further comprising a third valve for releasing tea latte from the boiler.

8. The apparatus of claim 1 further comprising an actuator to move a tea cartridge into the boiler.

9. The apparatus of claim 1 further comprising a microprocessor positioned within the body to process preparation parameters.

10. The apparatus of claim 1 further comprising a filter to collect tea residue.
